(19) United States
(12) Patent Application Publication
(10) Pub. No.: US 2025/0218129 A1
(43) Pub. Date: Jul. 3, 2025

(54) METHOD AND DISPLAY APPARATUS INCORPORATING GENERATION OF CONTEXT-AWARE TRAINING DATA

(71) Applicant: Varjo Technologies Oy, Helsinki (FI)

(72) Inventors: Ville Timonen, Helsinki (FI); Mikko Ollila, Tampere (FI); Mikko Strandborg, Hangonkylä (FI)

(73) Assignee: Varjo Technologies Oy, Helsinki (FI)

(21) Appl. No.: 18/397,163

(22) Filed: Dec. 27, 2023

(51) Int. Cl. G06T 19/00; G06F 3/01; G06T 7/00; G06T 7/50; G06T 7/70

(52) U.S. Cl. CPC G06T 19/006; G06F 3/013; G06T 7/0002; G06T 7/50; G06T 7/70; G06T 2207/20081; G06T 2207/20084; G06T 2207/30168; G06T 2207/30244

(57) ABSTRACT

Disclosed is a method including determining a gaze point and a gaze depth; controlling camera(s) for capturing a real-world image, by adjusting camera settings according to the gaze point and the gaze depth; determining a pose of the camera(s) at a time of capturing the real-world image; identifying region(s) of the real-world environment represented in the real-world image; determining whether a representation of region(s) satisfies quality criteria; when the representation fails to satisfy the quality criteria, capturing a reference real-world image such that the representation fulfills the quality criteria; generating training data comprising reference data and input data wherein reference data comprises reference real-world image, and input data with real-world image and/or previously-captured real-world image; sending training data to a processor to train a first neural network.

### TECHNICAL FIELD

The present disclosure relates to methods incorporating generation of context-aware training data. The present disclosure also relates to display apparatus incorporating generation of context-aware training data.

### BACKGROUND

Nowadays, in case of evolving technologies such as immersive extended-reality (XR) technologies, there is a high demand for developments in image processing that typically cannot be solved solely by a camera hardware. Such demands include achieving human-eye resolution across a field-of-view, a large field-of-view, a high dynamic range, elimination of motion blur and defocus blur, and the like, in an image.

Deep learning methods are being adopted for catering to such a demand. However, performance of such deep learning methods is highly dependent on a quality of training data. In addition to this, a necessity of identifying high-quality training data poses a significant challenge, particularly in various fields such as entertainment, real estate, training, medical imaging operations, simulators, navigation, and the like. Generally, the training data (that is used for training a neural network) is not optimised for each use case, and the neural network trained with such training data often produce factually incorrect results in some use cases. Typically, a conventional approach to training neural networks involves collecting a large generic dataset and manually auditing poor/inaccurate information. This conventional approach is inefficient and lacks scalability, especially when transitioning towards generating use-case specific training data.

Some existing techniques for training neural network utilises reinforcement learning with human feedback (RLHF). This involves training a reward model directly from human feedback, and utilizing it as a reward function to optimize an agent's policy via reinforcement learning, by employing an algorithm such as a proximal policy optimization algorithm. In the RLHF, human feedback is collected to improve a behaviour of a neural network or an artificial intelligence (AI) model. However, this demands significant human effort, and is time-consuming, resource-intensive, and potentially hindering an efficiency and a scalability of for optimising the neural network or the AI model. Additionally, reliance on human feedback introduces possibility of inconsistencies and biases, thereby further complicating refinement of the behaviour of the neural network or the AI model.

Therefore, in light of the foregoing discussion, there exists a need to overcome the aforementioned drawbacks.

### SUMMARY

The present disclosure seeks to provide a method and a display apparatus to generate high-quality, accurate training data for training a neural network to generate real-world images that satisfy quality criteria. The aim of the present disclosure is achieved by a method and a display apparatus which incorporate generation of context-aware training data, as defined in the appended independent claims to which reference is made to. Advantageous features are set out in the appended dependent claims.

Throughout the description and claims of this specification, the words “comprise”, “include”, “have”, and “contain” and variations of these words, for example “comprising” and “comprises”, mean “including but not limited to”, and do not exclude other components, items, integers or steps not explicitly disclosed also to be present. Moreover, the singular encompasses the plural unless the context otherwise requires. In particular, where the indefinite article is used, the specification is to be understood as contemplating plurality as well as singularity, unless the context requires otherwise.

### BRIEF DESCRIPTION OF THE DRAWINGS

FIG. 1 illustrates a block diagram of a display apparatus incorporating generation of context-aware training data, in accordance with an embodiment of the present disclosure;

FIG. 2 illustrates an exemplary scenario of transferring learning of a first neural network to a second neural network, in accordance with an embodiment of the present disclosure;

FIG. 3 illustrates steps of a method incorporating generation of context-aware training data, in accordance with an embodiment of the present disclosure; and

FIGS. 4A, 4B, 4C, and 4D illustrated are different exemplary scenarios for which training data is generated, in accordance with different embodiments of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In a first aspect, an embodiment of the present disclosure provides a method comprising:
determining a gaze point and a gaze depth of a user's eyes, by processing gaze-tracking data that is collected by a gaze-tracking means;
controlling at least one camera for capturing a real-world image of a real-world environment, by adjusting camera settings according to the gaze point and the gaze depth;
determining a pose of the at least one camera at a time of capturing the real-world image, by processing pose-tracking data that is collected by a pose-tracking means;
identifying at least one region of the real-world environment that is represented in the real-world image, based on a spatial geometry of the real-world environment and the pose of the at least one camera;
determining whether a representation of the at least one region in at least one of: the real-world image, a previously-captured real-world image, satisfies a quality criteria, wherein the previously-captured image is stored at a data repository;
when it is determined that the representation of the at least one region in the at least one of: the real-world image, the previously-captured real-world image, fails to satisfy the quality criteria, controlling the at least one camera for capturing a reference real-world image representing the at least one region, by adjusting the camera settings such that said representation fulfills the quality criteria;
generating training data comprising reference data and input data, wherein the reference data comprises the reference real-world image, and the input data comprises the at least one of: the real-world image, the previously-captured real-world image; and
sending the training data to a processor that is configured to train a first neural network for generating real-world images that satisfy the quality criteria by processing real-world images that fail to satisfy the quality criteria.

In a second aspect, an embodiment of the present disclosure provides a display apparatus comprising:
a gaze-tracking means;
a pose-tracking means;
at least one camera; and
at least one processor configured to:
   determine a gaze point and a gaze depth of a user's eyes, by processing gaze-tracking data that is collected by the gaze-tracking means;
   control the at least one camera to capture a real-world image of a real-world environment, by adjusting camera settings according to the gaze point and the gaze depth;
   determine a pose of the at least one camera at a time of capturing the real-world image, by processing pose-tracking data that is collected by the pose-tracking means;
   identify at least one region of the real-world environment that is represented in the real-world image, based on a spatial geometry of the real-world environment and the pose of the at least one camera;
   determine whether a representation of the at least one region in at least one of: the real-world image, a previously-captured real-world image, satisfies a quality criteria, wherein the previously-captured image is stored at a data repository that is communicably coupled with the at least one processor;
   when it is determined that the representation of the at least one region in the at least one of: the real-world image, the previously-captured real-world image, fails to satisfy the quality criteria, control the at least one camera to capture a reference real-world image representing the at least one region, by adjusting the camera settings such that said representation fulfills the quality criteria;
   generate training data comprising reference data and input data, wherein the reference data comprises the reference real-world image, and the input data comprises the at least one of: the real-world image, the previously-captured real-world image; and
   send the training data to a processor that is configured to train a first neural network to generate real-world images that satisfy the quality criteria by processing real-world images that fail to satisfy the quality criteria.

The present disclosure provides the aforementioned method and the aforementioned display apparatus for generating high-quality, accurate training data for training the first neural network to generate (upon said training) real-world images that satisfy quality criteria by processing real-world images that fail to satisfy the quality criteria. When at least the real-world image fails to satisfy the quality criteria (i.e., when the at least one region in the real-world image is accurately captured), the reference real-world image is captured in a manner that the quality criteria is satisfied. In such a case, the reference real-world image is served as the reference data (namely, ground-truth data) and the real-world image is served as the input data. This is because the reference real-world image would have considerably higher resolution and represents higher visual details (i.e., no blur, no noise, or the like), as compared to the at least one of: the real-world image, the previously-captured real-world image, that fails to satisfy the quality criteria. Such a training approach does not require manual labour, and is not time-consuming and resource-intensive. The method and the display apparatus are simple, robust, fast, reliable, support real-time generation of context-aware training data, and can be implemented with ease.

Throughout the present disclosure, the term “gaze-tracking means” refers to specialized equipment for detecting and/or following gaze of user's eyes, when the display apparatus in operation is worn by the user. The gaze-tracking means could be implemented as contact lenses with sensors, cameras monitoring a position, a size and/or a shape of a pupil of the user's eye, and the like. Such gaze-tracking means are well-known in the art.

It will be appreciated that the gaze-tracking data is collected repeatedly by the gaze-tracking means throughout a given session of using the display apparatus, as gaze of the user's eyes keeps changing whilst he/she uses the display apparatus. Optionally, when processing the gaze-tracking data, the processor is configured to employ at least one of: an image processing algorithm, a feature extraction algorithm, a data processing algorithm. Determining the gaze point and the gaze depth of the user's eyes allows the at least one processor to track where the user is looking/gazing. Processing the gaze-tracking data to determine the gaze point and the gaze depth is well-known in the art. Optionally, the gaze-tracking data comprises at least one of: images of the user's eyes, videos of the user's eyes, sensor values.

The term “gaze point” refers to a location within a field of view of the user where the user's eyes are directed/focused. In other words, the gaze point represents gaze-contingent object or its part present in a real-world environment. Furthermore, the term “gaze depth” refers to a distance of an object (or its part) present in a given region of the real-world environment from the user's eye. In other words, the gaze depth is indicative of how far or near the user's focus is from his/her current position. The gaze point and the gaze depth are well-known in the art.

Throughout the present disclosure, the term “display apparatus” refers to a specialized equipment that is capable of at least displaying images. These images are to be presented to a user of the display apparatus. It will be appreciated that the term “display apparatus” encompasses a head-mounted display (HMD) device and optionally, a computing device communicably coupled to the HMD device. The term “head-mounted display” device refers to specialized equipment that is configured to present an extended-reality (XR) environment to the user when said HMD device, in operation, is worn by the user on his/her head. The HMD device is implemented, for example, as an XR headset, a pair of XR glasses, and the like, that is operable to display a visual scene of the XR environment to the user. Examples of the computing device include, but are not limited to, a laptop, a desktop, a tablet, a phablet, a personal digital assistant, a workstation, and a console. The term “extended-reality” encompasses virtual reality (VR), augmented reality (AR), mixed reality (MR), and the like.

Notably, the at least one processor controls an overall operation of the display apparatus. The at least one processor is communicably coupled to the gaze-tracking means, the pose-tracking means, and the at least one camera.

Throughout the present disclosure, the term “camera” refers to an equipment that is operable to detect and process light signals received from the real-world environment, so as to capture real-world images of the real-world environment. Optionally, the at least one camera is implemented as a visible-light camera. Examples of the visible-light camera include, but are not limited to, a Red-Green-Blue (RGB) camera, a Red-Green-Blue-Alpha (RGB-A) camera, a Red-Green-Blue-Depth (RGB-D) camera, an event camera, and a monochrome camera. Alternatively, optionally, the at least one camera is implemented as a combination of a visible-light camera and a depth camera. Examples of the depth camera include, but are not limited to, a Red-Green-Blue-Depth (RGB-D) camera, a ranging camera, a Light Detection and Ranging (LIDAR) camera, a Time-of-Flight (ToF) camera, a Sound Navigation and Ranging (SONAR) camera, a laser rangefinder, a stereo camera, a plenoptic camera, and an infrared (IR) camera. As an example, the at least one camera may be implemented as the stereo camera.

It will be appreciated that a given real-world image is a visual representation of the real-world environment. The term “visual representation” encompasses colour information represented in the given real-world image, and additionally optionally other attributes associated with the given real-world image (for example, such as depth information, luminance information, transparency information (namely, alpha values), polarization information and the like). Optionally, the real-world image is a video see-through (VST) image.

It will also be appreciated that once the gaze point and the gaze depth are known, the camera settings (for example, a focus distance of the at least one camera) are adjusted (namely, modified) by the at least one processor accordingly. Then, the at least one processor controls the at least one camera to capture the real-world image by utilising the (adjusted) camera settings. In other words, the camera settings are adjusted to align with user's focus (i.e., where exactly the user is looking, how far or near the user's eyes are gazing), for capturing the real-world image. This may potentially provide an accurate visual representation of a real-world scene (being observed by the user) in the real-world image. Capturing the real-world image by adjusting the camera settings is well-known in the art.

Optionally, the camera settings comprise at least one of: a focus distance, an exposure, a white balance, of the at least one camera. The term “focus distance” refers to a distance between optics (such as lens) of a given camera and a point where light rays converge, to form an image. Adjusting the focus distance generally allows to capture clear and sharp images of objects at different distances from the given camera. The term “exposure” refers to a time span for which a photo-sensitive surface of an image sensor of a given camera is exposed to light, so as to capture an image of a real-world scene of the real-world environment. The term “white balance” refers to an adjustment of colours in an image to ensure that white objects represented in the image appear neutral and without any unwanted colour cast in the image. It will be appreciated that the camera settings may further comprise other parameters, for example, such as an aperture size, a shutter speed, a sensitivity, and the like, of the at least one camera.

Throughout the present disclosure, the term “pose-tracking means” refers to specialized equipment that is employed to detect and/or follow a pose of the at least one camera. The term “pose” encompasses a viewing position and/or a viewing orientation of the at least one camera in the real-world environment. Optionally, the pose-tracking means is employed to track a pose of the HMD device that is worn by the user on his/her head, when the at least one camera is mounted on the HMD device. Thus, in such a case, the pose of the at least one camera changes according to a change in the pose of the HMD device.

Pursuant to embodiments of the present disclosure, the pose-tracking means is implemented as a true six Degrees of Freedom (6DoF) tracking system. In other words, the pose-tracking means tracks both a viewing position and/or a viewing orientation of the at least one camera within a three-dimensional (3D) space of the real-world environment. In particular, said pose-tracking means is configured to track translational movements (namely, surge, heave and sway movements) and rotational movements (namely, roll, pitch and yaw movements) of the at least one camera within the 3D space. The pose-tracking means could be implemented as at least one of: an optics-based tracking system (which utilizes, for example, infrared beacons and detectors, infrared cameras, visible-light cameras, and the like), an acoustics-based tracking system, a radio-based tracking system, a magnetism-based tracking system, an accelerometer, a gyroscope, an Inertial Measurement Unit (IMU), a Timing and Inertial Measurement Unit (TIMU). The pose-tracking means are well-known in the art.

Optionally, when determining the pose of the at least one camera, the at least one processor is configured to employ at least one data processing algorithm to process the pose-tracking data. The pose-tracking data may be in the form of images, IMU/TIMU values, motion sensor data values, magnetic field strength values, or similar. Examples of the at least one data processing algorithm include, but are not limited to, a feature detection algorithm, an environment mapping algorithm, and a data extrapolation algorithm. It will be appreciated that the pose-tracking means continuously tracks the pose of the at least one camera throughout a given session of using the display apparatus (such as the HMD device). In such a case, the at least one processor continuously determines the pose of the at least one camera (in real time or near-real time).

Throughout the present disclosure, the term “spatial geometry” of the real-world environment refers to comprehensive information pertaining to objects or their parts present within the 3D space of the real-world environment. Such comprehensive information is indicative of at least one of: surfaces of the objects or their parts, a plurality of features of the objects or their parts, shapes and sizes of the objects or their parts, poses of the objects or their parts, materials of the objects or their parts, colour information of the objects or their parts, depth information of the objects or their parts, light sources and lighting conditions within the real-world environment. The term “object” refers to a physical object or a part of the physical object that is present in the real-world environment. An object could be a living object (for example, such as a human, a pet, a plant, and the like) or a non-living object (for example, such as a wall, a building, a shop, a road, a window, a toy, a poster, a lamp, and the like).

Examples of the plurality of features include, but are not limited to, edges, corners, blobs, a high-frequency feature, a low-frequency feature, and ridges.

Optionally, the spatial geometry of the real-world environment is known from a 3D model of the real-world environment. The term “three-dimensional model” of the real-world environment refers to a data structure that comprises the aforesaid comprehensive information pertaining to the objects or their parts present in the real-world environment. Optionally, the 3D model is in a form of one of: a 3D polygonal mesh, a 3D point cloud, a 3D surface cloud, a 3D surflet cloud, a voxel-based model, a parametric model, a 3D grid, a 3D hierarchical grid, a bounding volume hierarchy, an image-based 3D model. The 3D polygonal mesh could be a 3D triangular mesh or a 3D quadrilateral mesh. The aforesaid forms of the 3D model are well-known in the art.

Optionally, the at least one processor is configured to pre-store the 3D model at the data repository. It will be appreciated that the data repository could be implemented, for example, such as a memory of the at least one processor, a memory of the computing device, a memory of the display apparatus, a removable memory, a cloud-based database, or similar. Optionally, the display apparatus further comprises the data repository. Alternatively, optionally, the at least one processor is configured to generate the spatial geometry (for example, from the 3D model), prior to a given session of using the display apparatus. Once the pose of the at least one camera and the spatial geometry of the real-world environment are known to the at least one processor, the at least one region (that is represented in the real-world image) can be easily and accurately identified by the at least one processor, for example, by mapping the pose of the at least one camera with the spatial geometry, wherein a corresponding portion in the spatial geometry (namely, in the 3D model) that is visible from a perspective of said pose is identified as the at least one region.

Optionally, the method further comprises determining the spatial geometry of the real-world environment by processing sensor data that is collected by at least one depth sensor. In this regard, instead of obtaining the spatial geometry, the at least one processor determines the spatial geometry itself, using the at least one depth sensor. It will be appreciated that the sensor data that is collected by the at least one depth sensor comprises depth information (namely, optical distances) of the objects or their parts in the real-world environment from different perspectives of poses of the at least one depth sensor. Such depth information could be represented using depth maps, depth images, 3D point clouds, and the like. Since the sensor data comprising the depth information would be indicative of placements, textures, geometries, occlusions, and the like, of the objects or their parts, the at least one processor can easily and accurately reconstruct surfaces and spatial geometries of said objects or their portions, to determine the spatial geometry of the real-world environment. Optionally, the at least one depth sensor is a part of the depth camera.

Notably, the at least one processor determines whether the representation of the at least one region in the at least one of: the real-world image, the previously-captured real-world image, satisfies the quality criteria, in order to generate the training data for training the first neural network (as discussed later). In this regard, said determination involves analysing the visual representation (for example, colour information, depth information, luminance information, and the like) of the at least one region in the at least one of: the real-world image, the previously-captured real-world image, for example, in a pixel-by-pixel manner, in order to determine whether said representation fulfills (satisfies) the quality criteria or does not meet the quality criteria. The term “quality criteria” refers to attributes or characteristics of at least a region of a real-world image that are used to assess an overall visual quality of at least said region of the real-world image. Greater the extent of satisfaction of the quality criteria, greater is the accuracy of representation of the at least one region in the at least one of: the real-world image, the previously-captured real-world image, and vice versa.

Optionally, the quality criteria comprises at least one of: absence of defocus blur; absence of motion blur; absence of saturation; absence of noise; and a spatial resolution being higher than a predefined threshold. The term “defocus blur” refers to a phenomenon where a region of a given real-world image is not in focus (namely, is blurred). An absence of the defocus blur ensures that the given real-world image is in-focus (namely, well-focused without any noticeable blurring). The term “motion blur” is a phenomenon where an object in a given real-world image appears to be blurred when there is a relative motion between a camera (capturing the given real-world image) and the real-world object. Such a blurring may occur along in a direction of the relative motion. An absence of the motion blur ensures that there is no blurring caused by motion of objects and/or the camera when capturing the given real-world image. The term “saturation” refers to a phenomenon where colours in a given real-world image are over intensified or overly vivid. in the real-world image. A highly saturated real-world image has more vibrant and intense colors, while a desaturated real-world image has more desaturated or subdued colours. An absence of the saturation ensures there are no overly vivid or no overly intense colours in the given real-world image. The term “noise” in a given real-world image refers to unwanted random variations in brightness or colours in the given real-world image. The noise appears as grainy or speckled patterns, especially in low-light conditions or when using a high-ISO setting when capturing an image. Such a noise degrades an overall image quality of the given real-world image (for example, reduces its clarity and sharpness). The term “spatial resolution” refers to a level of detail that can be captured or displayed in a given real-world image. The spatial resolution may, for example, be defined in terms of pixels per degree (PPD). Greater the spatial resolution, greater is the level of detail represented in the given real-world image, and greater is the image quality of the given real-world image. The “predefined threshold” refers to a minimum acceptable spatial resolution of the given real-world image, in order to satisfy the quality criteria. Optionally, the predefined threshold lies in a range of 20 PPD to 60 PPD. It will be appreciated that instead of considering an absence of any blur (i.e., the defocus blur and/or the motion blur) in a region of a given real-world image to be strictly zero, even when a level of any blur (i.e., the defocus blur and/or the motion blur) in said region is less than a predefined percent (for example, 20-40 percent) from a maximum blur level (for example, equal to 1), it could be considered that said region has no blur (i.e., the absence of the defocus blur and/or the motion blur in said region). In such a case, the representation of the at least one region would still satisfy the quality criteria. Moreover, the spatial resolution typically depends on the level of any blur in said region, i.e., lesser the level of blur, greater is the spatial resolution in said region, and vice versa. In this regard, the spatial resolution could also be determined by taking into account the predefined percent of the maximum blur level.

Notably, when it is determined that the aforesaid representation fails to satisfy (namely, does not fulfill) the quality criteria, it means that the at least one region in the at least one of: the real-world image, the previously-captured real-world image, has been poorly/inaccurately captured (i.e., of sub-optimal image quality). Thus, the at least one region would have at least one of: a presence of the defocus blur, a presence of the noise, a presence of the motion blur, a presence of saturation, a spatial resolution lower than the predefined threshold. Consequently, when, for the at least one region, there does not exist imagery which fulfils the quality criteria, there is a need to capture the reference real-world image that fulfils the quality criteria.

Throughout the present disclosure, the “reference real-world image” refers to a real-world image that is captured by adjusting the camera settings in a manner that the representation of the at least one region in said real-world image fulfills the quality criteria. Beneficially, due to this, the reference real-world image could be served as a ground-truth image, and thus could be utilised as the reference data in the training data for training the first neural network (as discussed later). This is because the reference real-world image would have considerably higher resolution and represents higher visual details (i.e., no blur, no noise, or the like), as compared to the at least one of: the real-world image, the previously-captured real-world image, that fails to satisfy the quality criteria.

Optionally, the step of controlling the at least one camera for capturing the reference real-world image comprises:
determining reference values of the camera settings based on at least one of: an optical depth of the at least one region, lighting conditions in the at least one region, such that the reference values, when employed, enable the representation of the at least one region in the reference real-world image to satisfy the quality criteria; and
generating a control signal for the at least one camera to employ the determined reference values of the camera settings, for capturing the at least one reference real-world image.

In this regard, when the optical depth of the at least one region and/or the lighting conditions in the at least one region is/are accurately known to the at least one processor, the reference values of the camera settings would be highly accurately determined. Thus, there is no likelihood of capturing the at least one region with any blur/noise or a reduced spatial resolution, thereby facilitating the at least one camera to capture the at least one region with a high accuracy, such that the representation of the at least one region in the reference real-world image satisfies the quality criteria. Moreover, when the optical depth and the lighting conditions are taken into account, it may be ensured that the camera settings are accurate enough to represent objects or their parts present in the at least one region at correct optical depth(s), and to correctly handle variations in lighting at the illumination parameter region. This would potentially contribute to a high quality of the captured reference real-world image. The optical depth of the at least one region can be determined, for example, from a depth map generated by the at least one depth sensor. The lighting conditions in the at least one region can be determined, for example, at least one of: the 3D model of the real-world environment, a lighting model of the real-world environment. The lighting conditions may, for example, be bright lighting conditions, dim lighting conditions, day-light lighting conditions, and the like. The term “lighting model” refers to a data structure comprising information pertaining to lighting conditions in the real-world environment. Techniques for determining optical depths and lighting conditions in the real-world environment are well-known in the art. Optionally, once the reference values are determined, the control signal is generated and sent to the at least one camera for capturing the at least one reference real-world image. In such a case, the control signal may instruct a hardware of the at least one camera to utilise the reference values, for capturing the at least one reference real-world image.

It will be appreciated that in some scenarios, the at least one camera may capture two or more reference real-world images representing the at least one region at different time instants during a given session of using the display apparatus. In such a case, the at least one processor is optionally configured to: determine differences between the two or more reference real-world images amongst each other by employing a difference metric; and for a reference real-world image whose difference from at least one other reference real-world image exceeds a predefined threshold difference, prioritise said reference real-world image for generating the reference data in the training data. Optionally, the difference metric is based on at least one of: a Mean-Squared Error (MSE) value, a Peak Signal-to-Noise Ratio (PSNR) value, a Structural Similarity Index Measure (SSIM) value, a Feature Similarity Indexing Measure (FSIM) value. The aforesaid basis for the difference metric is well-known in the art. Information pertaining to some of the aforesaid difference metrics is described, for example, in “Image Quality Assessment through FSIM, SSIM, MSE and PSNR—A Comparative Study” by Umme Sara et al., published in Journal of Computer and Communications, pp. 8-18, 2019, which has been incorporated herein by reference. Notably, once the quality criteria for the representation of the at least one region is failed, and the reference real-world image is captured, the training data is generated by the at least one processor. Throughout the present disclosure, the term “training data” refers to information that is utilised to train a given neural network, and to improve weights and biases of the given neural network during its learning process. It will be appreciated that the reference data (comprising the reference real-world image) is served as ground-truth data to the given neural network for its learning/training, whereas the input data (comprising the at least one of: the real-world image, the previously-captured real-world image) is served as an input (in other words, a raw material or an initial set of information) to the given neural network for its learning/training. Upon said generation of the training data, the training data is sent to the processor, wherein said processor trains the first neural network for generating the real-world images that satisfy the quality criteria.

In some implementations, the processor is implemented as the at least one processor of the display apparatus. In such a case, the aforementioned steps of the method are performed by the at least one processor, to train the first neural network (i.e., in case of a self-contained VST improvement implementation). In other implementations, the processor is implemented as a processor of a server that is external to the display apparatus (for example, in case of the HMD). In such a case, the aforementioned steps of the method are performed by the at least one processor, and the training of the first neural network is performed at the processor of the server. Optionally, the at least one processor is communicably coupled to the processor of the server, via a communication network.

It will be appreciated that the given neural network learns from differences between the reference real-world image and the at least one of: the real-world image, the previously-captured real-world image, to improve its ability to generate the real-world images that would satisfy the quality criteria. Such an adaptive training process contributes to an overall enhancement in an image generation process. Moreover, during the training process, the given neural network iteratively processes the training data, makes predictions, compares them with the reference data, and adjusts its internal parameters using well-known algorithms (such as a gradient descent algorithm) to minimize a prediction error. This process may continue until the given neural network achieves a satisfactory level of performance on the training data. Techniques and/or algorithms for training neural networks using training data are well-known in the art.

Optionally, the method further comprises:
when it is determined that the representation of the at least one region is represented in the at least one of: the real-world image, the previously-captured real-world image, satisfies the quality criteria, controlling the at least one camera for capturing an input real-world image representing the at least one region, by adjusting the camera settings such that said representation fails to satisfy the quality criteria;
generating training data comprising reference data and input data, wherein the reference data comprises the at least one of: the real-world image, the previously-captured real-world image, and the input data comprises the input real-world image; and
sending the training data to a processor that is configured to train a first neural network for generating real-world images that satisfy the quality criteria by processing real-world images that fail to satisfy the quality criteria.

In this regard, when it is determined that the aforesaid representation satisfies (namely, fulfill) the quality criteria, it means that the at least one region in the at least one of: the real-world image, the previously-captured real-world image, has been accurately and realistically captured (i.e., of optimal image quality). Thus, the at least one region would have at least one of: an absence of the defocus blur, an absence of the noise, an absence of the motion blur, an absence of saturation, a spatial resolution being higher than the predefined threshold. Consequently, when, for the at least one region, there exists imagery which fulfils the quality criteria, there may be a need to capture the input real-world image that fails to fulfil the quality criteria. In other words, when the previously-captured real-world image and the real-world image are both high-quality images, then that means input data (i.e., erroneous data) for training the given neural network is not available. This means the input real-world image is deliberately captured with a poor image quality, by adjusting the camera settings to intentionally introduce at least one of: a defocus blur, a motion blur, saturation, a noise, a low spatial resolution, in the input real-world image, ensuring that the input real-world image does not meet the quality criteria.

Throughout the present disclosure, the “input real-world image” refers to a real-world image that is captured by adjusting the camera settings in a manner that the representation of the at least one region in the input real-world image does not fulfill the quality criteria. Due to this, the (intentionally-degraded) input real-world image could be served as the input data in the training data, and the at least one of: the real-world image, the previously-captured real-world image, could be served as the reference data in the training data, for training the first neural network. This is because the input real-world image would have considerably lower resolution and represents poor visual details (i.e., blurred, noise, or the like), as compared to the at least one of: the real-world image, the previously-captured real-world image that satisfies the quality criteria. Information pertaining to generation of the training data and training of the first neural network (upon receiving the training data) will be performed in a similar manner to what has already been discussed earlier in detail.

Optionally, the method further comprises:
receiving, from the processor, weights of the first neural network that are learnt upon the training of the first neural network at the processor;
transferring learning of the first neural network to a second neural network, by applying the weights to the second neural network; and
processing real-world images that do not satisfy the quality criteria, captured by the at least one camera after the step of transferring learning, for generating corresponding real-world images that satisfy the quality criteria, by employing the second neural network.

In this regard, after the first neural network has undergone training at the processor (which could the at least one processor of the display apparatus or the processor of the server), the weights of the first neural network are sent to the second neural network. Said weights would be applied to an architecture of the second neural network. In this way, the second neural network would be equipped with a knowledge gained by the (already trained) first neural network. Transferring learnings of one neural network to another neural network is well-known in the art. Beneficially, this facilitates in saving considerable training time and processing resources that would be employed when the second neural network would have to be trained from scratch. This may, particularly, be beneficial in a scenario when the first neural network has been (externally) trained at the server, and the second neural network is to be employed by the at least one processor of the display apparatus. Upon such a transfer learning, when the second neural network has been trained, it could easily process the real-world images that do not initially satisfy the quality criteria to generate the corresponding real-world images that eventually satisfy the quality criteria.

Optionally, the method further comprises:
generating an extended-reality image using the real-world image; and
controlling at least one display, for displaying the extended-reality image.

Optionally, when generating the extended-reality (XR) image using the real-world image, the at least one processor is configured to digitally superimpose at least one virtual object upon at least one region of the real-world image. In other words, the real-world image gets digitally modified when the at least one virtual object is overlaid thereupon. Optionally, in this regard, the at least one processor is configured to employ at least one image processing algorithm. Image processing algorithms for generating XR images are well-known in the art. Upon generating the XR image, the XR image is displayed at the at least one display. Optionally, the at least one display is implemented as a display or a projector. Displays and projectors are well-known in the art. A given display may be a single-resolution display or a multi-resolution display.

Throughout the present disclosure, the term “virtual object” refers to a computer-generated object (namely, a digital content). Examples of the at least one virtual object may include, but are not limited to, a virtual navigation tool (such as a virtual map, a virtual direction signage, and so forth), a virtual gadget (such as a virtual calculator, a virtual computer, and so forth), a virtual message (such as a virtual instant message, a virtual to-do note, and so forth), a virtual entity (such as a virtual person, a virtual mascot, a virtual animal, a virtual ghost, and so forth), a virtual logo of a company, a virtual entertainment media (such as a virtual painting, a virtual video, a virtual advertisement, and so forth), a virtual vehicle or part thereof (such as a virtual car, a virtual cockpit, and so forth), and a virtual information (such as a virtual notification, a virtual news description, a virtual announcement, virtual data, and so forth).

Optionally, the method further comprises:
generating at least one reprojected real-world image, by timewarping the real-world image, during a time period of controlling the at least one camera for capturing the reference real-world image, wherein upon elapsing of said time period, the method further comprises controlling the at least one camera for capturing a next real-world image;
generating at least one extended-reality image using the at least one reprojected real-world image; and
controlling at least one display, for displaying the at least one extended-reality image until a next extended-reality image that is generated using the next real-world image is generated for displaying.

In this regard, it may be likely that during the time period of controlling the at least one camera for capturing the reference real-world image, a head pose of the user may be changed, and the XR image (that was generated using the real-world image) currently being displayed to the user would no longer be relevant according to his/her changed head pose. Moreover, generation of subsequent XR images would also occur once said time period is elapsed. Therefore, during said time period, the at least one XR image (that is generated using the at least one reprojected real-world image) would be displayed to the user (via the at least one display). Advantageously, this facilitates in achieving considerable realism and immersiveness within an XR environment, as a viewing experience of the user would be continuous and seamless even during said time period. Moreover, the aforesaid timewarping also facilitates in achieving a considerably high frame rates. The timewarping may also help in maintaining visual stability and reducing motion artifacts, thereby providing a more comfortable visual experience for the user. When the time period elapses, the next real-world image is captured by the at least one camera, and then the next XR image would be generated for displaying, after displaying the at least one XR image.

Optionally, the at least one processor is configured to generate the at least one reprojected real-world image by timewarping (namely, reprojecting) the real-world image according to a change in a head pose of the user. In simpler terms, a perspective of the real-world image is changed from an initial head pose of the user to a subsequent head pose of the user. Optionally, the at least one processor is configured to employ at least one timewarping algorithm for performing the timewarping. The at least one timewarping algorithm comprises at least space-warping algorithm. Timewarping algorithms (namely, reprojection algorithms) are well-known in the art. Generating the XR image using the at least one reprojected real-world image, and generating the next XR image using the next real-world image are performed in a similar manner as discussed earlier.

The present disclosure also relates to the display apparatus as described above. Various embodiments and variants disclosed above, with respect to the aforementioned method, apply mutatis mutandis to the display apparatus.

Optionally, in the display apparatus, the quality criteria comprises at least one of:
absence of defocus blur;
absence of motion blur;
absence of saturation;
absence of noise;
a spatial resolution being higher than a predefined threshold.

Optionally, in the display apparatus, the camera settings comprise at least one of: a focus distance, an exposure, a white balance, of the at least one camera.

Optionally, in the display apparatus, when controlling the at least one camera for capturing the reference real-world image, the at least one processor is configured to:
determine reference values of the camera settings based on at least one of: an optical depth of the at least one region, lighting conditions in the at least one region, such that the reference values, when employed, enable the representation of the at least one region in the reference real-world image to satisfy the quality criteria; and
generate a control signal for the at least one camera to employ the determined reference values of the camera settings, for capturing the at least one reference real-world image.

Optionally, in the display apparatus, the at least one processor is configured to:
receive, from the processor, weights of the first neural network that are learnt upon the training of the first neural network at the processor;
transfer learning of the first neural network to a second neural network, by applying the weights to the second neural network; and
process real-world images that do not satisfy the quality criteria, captured by the at least one camera after transferring said learning, to generate corresponding real-world images that satisfy the quality criteria, by employing the second neural network.

Optionally, in the display apparatus, the at least one processor is configured to:
generate an extended-reality image using the real-world image; and
control at least one display, for displaying the extended-reality image.

Optionally, in the display apparatus, the at least one processor is configured to:
generate at least one reprojected real-world image, by timewarping the real-world image, during a time period when the at least one camera is controlled for capturing the reference real-world image, wherein upon elapsing of said time period, the at least one processor is configured to control the at least one camera for capturing a next real-world image;
generate at least one extended-reality image using the at least one reprojected real-world image; and
control at least one display, for displaying the at least one extended-reality image until a next extended-reality image that is generated using the next real-world image is generated for displaying.

Optionally, in the display apparatus, the at least one processor is configured to:
when it is determined that the representation of the at least one region is represented in the at least one of: the real-world image, the previously-captured real-world image, satisfies the quality criteria, control the at least one camera to capture an input real-world image representing the at least one region, by adjusting the camera settings such that said representation fails to satisfy the quality criteria;
generate training data comprising reference data and input data, wherein the reference data comprises the at least one of: the real-world image, the previously-captured real-world image, and the input data comprises the input real-world image; and
send the training data to a processor that is configured to train a first neural network for generating real-world images that satisfy the quality criteria by processing real-world images that fail to satisfy the quality criteria.

Optionally, in the display apparatus, the at least one processor is configured to determines the spatial geometry of the real-world environment, by processing sensor data that is collected by at least one depth sensor.

### DETAILED DESCRIPTION OF THE DRAWINGS

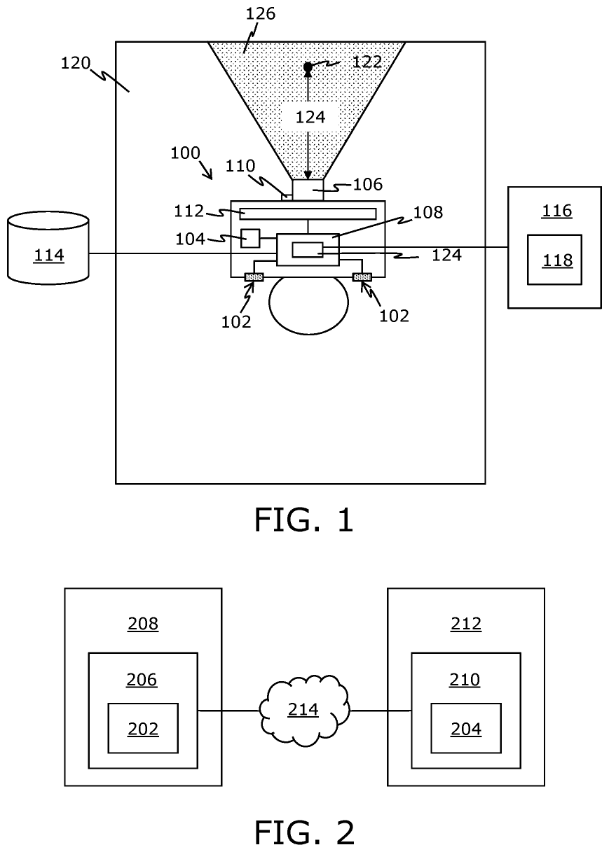

Referring to FIG. 1, illustrated is a block diagram of a display apparatus 100 incorporating generation of context-aware training data, in accordance with an embodiment of the present disclosure. The display apparatus 100 comprises a gaze-tracking means 102, a pose-tracking means 104, at least one camera (for example, depicted as a camera 106) and at least one processor (for example, depicted as a processor 108). Optionally, the display apparatus 100 further comprises at least one depth sensor (for example, depicted as a depth sensor 110), at least one display (for example, depicted as a display 112), and a data repository 114. The processor 108 is communicably coupled to the gaze-tracking means 102, the pose-tracking means 104, the camera 106, the depth sensor 110, the display 112, and the data repository 114. Furthermore, the processor 108 is also communicably coupled to another processor (depicted as a processor 116). The processor 116 is a processor of a server that is external to the display apparatus 100. The processor 116 is configured to train a first neural network 118 to generate real-world images that satisfy a quality criteria by processing real-world images that fail to satisfy the quality criteria.

The processor 108 is configured to perform various operations, as described earlier with respect to the aforementioned first aspect. In this regard, when the display apparatus 100 is employed in a real-world environment 120, a gaze point 122 and a gaze depth 124 of user's eyes is determined by processing gaze-tracking data that is collected by the gaze-tracking means 102, and the camera 106 is controlled to capture a real-world image of the real-world environment 120, by adjusting camera settings according to the gaze point 122 and the gaze depth 124. Furthermore, a pose of the camera 106 is determined at a time of capturing the real-world image, by processing pose-tracking data that is collected by the pose-tracking means 102. In this regard, at least one region 126 (depicted using a dotted pattern) of the real-world environment 120 that is represented in the real-world image is identified, based on a spatial geometry of the real-world environment 120 and the pose of the camera 106.

It may be understood by a person skilled in the art that FIG. 1 includes a simplified architecture of the display apparatus 100, for sake of clarity, which should not unduly limit the scope of the claims herein. It is to be understood that the specific implementation of the display apparatus 100 is provided as an example and is not to be construed as limiting it to specific numbers or types of gaze tracking means, pose tracking means, cameras, depth sensors, displays, data repositories, and processors. The person skilled in the art will recognize many variations, alternatives, and modifications of embodiments of the present disclosure.

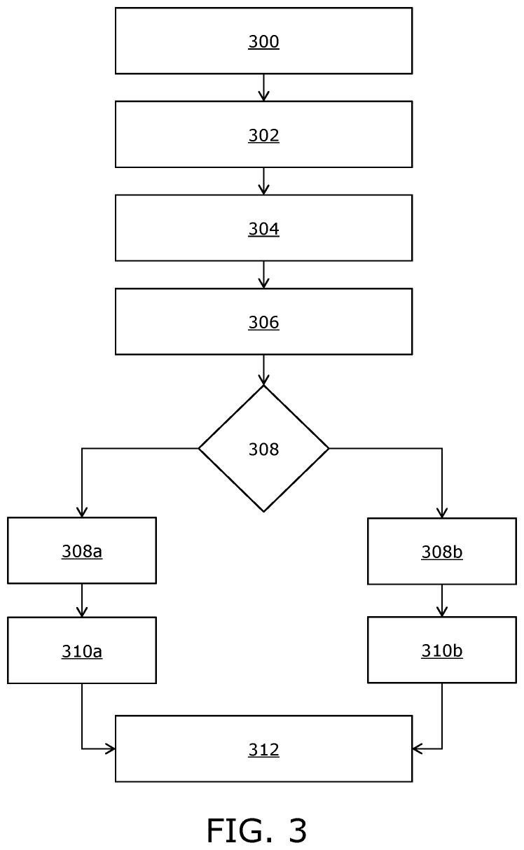

Referring to FIG. 2, illustrated is an exemplary scenario of transferring learning of a first neural network 202 to a second neural network 204, in accordance with an embodiment of the present disclosure. With reference to FIG. 2, the first neural network 202 is trained by a processor 206 of a server 208. At least one processor (depicted as a processor 210) of a display apparatus 212 is configured to receive, from the processor 206, weights of the first neural network 202 that are learnt upon training of the first neural network 202 at the processor 206. Upon receiving, learning of the first neural network 202 are transferred to the second neural network 204, by applying the weights to the second neural network 204, wherein the second neural network 204 is trained by the processor 210 of the display apparatus 212. Thus, the processor 210 is configured to process real-world images that do not satisfy quality criteria, for generating corresponding real-world images that satisfy the quality criteria, by employing the second neural network 204. The processor 206 of a server 208 is communicably coupled to the processor 210 of a display apparatus 212.

FIG. 2 is merely an example, which should not unduly limit the scope of the claims herein. The person skilled in the art will recognize many variations, alternatives, and modifications of embodiments of the present disclosure.

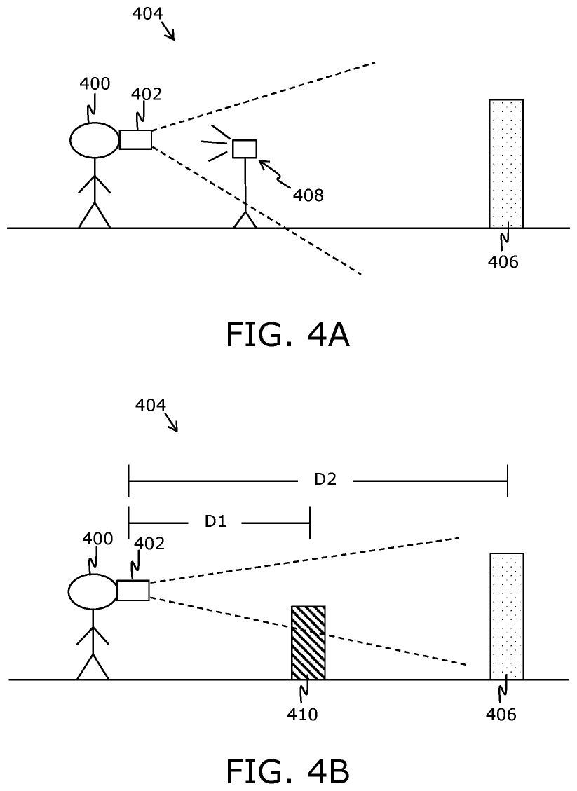

Referring to FIG. 3, illustrated are steps of a method incorporating generation of context aware training data, in accordance with an embodiment of the present disclosure. At step 300, a gaze point and a gaze depth of user's eyes are determined, by processing gaze-tracking data that is collected by gaze-tracking means. At step 302, at least one camera is controlled for capturing a real-world image of a real-world environment, by adjusting camera settings according to the gaze point and the gaze depth. At step 304, a pose of the at least one camera is determined at a time of capturing the real-world image, by processing pose-tracking data that is collected by a pose-tracking means. At step 306, at least one region of the real-world environment that is represented in the real-world image is identified, based on a spatial geometry of the real-world environment and the pose of the at least one camera. At step 308, it is determined whether a representation of the at least one region in at least one of: the real-world image, a previously-captured real-world image, satisfies a quality criteria, wherein the previously-captured image is stored at a data repository. When it is determined that the representation of the at least one region in the at least one of: the real-world image, the previously-captured real-world image, fails to satisfy the quality criteria, at step 308a, the at least one camera is controlled for capturing a reference real-world image representing the at least one region, by adjusting the camera settings such that said representation fulfills the quality criteria. Then, at step 310a, training data is generated, the training data comprising reference data and input data, wherein the reference data comprises the reference real-world image, and the input data comprises the at least one of: the real-world image, the previously-captured real-world image. Otherwise, when it is determined that the representation of the at least one region in the at least one of: the real-world image, the previously-captured real-world image, satisfies the quality criteria, at step 308b, the at least one camera is controlled for capturing an input real-world image representing the at least one region, by adjusting the camera settings such that said representation fails to satisfy the quality criteria. Then, at step 310b, training data is generated, the training data comprising reference data and input data, wherein the reference data comprises the at least one of: the real-world image, the previously-captured real-world image, and the input data comprises the input real-world image. At step 312, the training data (that is generated at the aforementioned steps 310a or 310b) is sent to a processor that is configured to train a first neural network, for generating real-world images that satisfy the quality criteria by processing real-world images that fail to satisfy the quality criteria.

The aforementioned steps are only illustrative and other alternatives can also be provided where one or more steps are added, one or more steps are removed, or one or more steps are provided in a different sequence without departing from the scope of the claims.

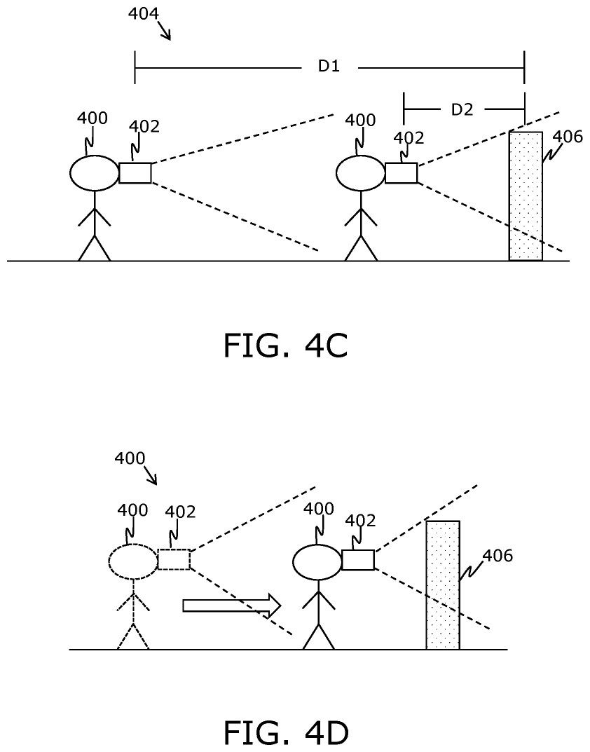

Referring to FIGS. 4A, 4B, 4C and 4D, illustrated are different exemplary scenarios for which training data is generated, in accordance with different embodiments of the present disclosure. With reference to FIG. 4A, a user 400 wearing a display apparatus 402 (being implemented as a head-mounted display device) is shown to be present in a region 404 of a real-world environment. As shown, in the region 404, the user 400 is viewing an object 406 (depicted using a dotted pattern), and a bright light source 408 is present in its field of view. Due to presence of the bright light source 408, a representation of the region 404 in a real-world image that is captured by a camera of the display apparatus 402, fails to satisfy a quality criteria (for example, an absence of saturation/noise). This means said region 404 in the real-world image has saturation/noise. In such a case, the camera is controlled to capture a reference real-world image representing said region 404, by adjusting camera settings such that the representation of said region 404 in the reference real-world image fulfills the quality criteria. This means said region 404 in the reference real-world image has no saturation/noise. Thus, in this scenario, the training data comprises reference data and input data, wherein the reference data comprises the reference real-world image, and the input data comprises the real-world image.

With reference to FIG. 4B, a user 400 wearing a display apparatus 402 (being implemented as a head-mounted display device) is shown to be present in a region 404 of a real-world environment. As shown, in the region 404, the user 400 is viewing objects 406 (depicted using a dotted pattern) and 410 (depicted using a slant line pattern) present in its field of view. The object 410 is present at an optical depth of D1, and the object 406 is present at an optical depth of D2. Herein, a representation of the region 404 in a real-world image that is captured by a camera of the display apparatus 402, fails to satisfy a quality criteria (for example, an absence of defocus blur). This means said region 404 in the real-world image is captured with defocus blur, such that a part of the object 410 is out-of-focus. In such a case, the camera is controlled to capture a reference real-world image representing said region 404, by adjusting camera settings such that the representation of said region 404 in the reference real-world image fulfills the quality criteria. This means said region 404 in the reference real-world image has no defocus blur. Thus, in this scenario, the training data comprises reference data and input data, wherein the reference data comprises the reference real-world image, and the input data comprises the real-world image.

With reference to FIG. 4C, a user 400 wearing a display apparatus 402 (being implemented as a head-mounted display device) is shown to be present in a region 404 of a real-world environment. As shown, in the region 404, the user 400 is viewing an object 406 (depicted using a dotted pattern) present in its field of view. When the user is present at a distance D1 from the object 406, a representation of the object 406 in a real-world image that is captured by a camera of the display apparatus 402, fails to satisfy a quality criteria (for example, a spatial resolution being higher than a predefined threshold). This means said object 406 in the real-world image is captured at a spatial resolution that is lower than the predefined threshold. In such a case, when the user is present at a distance D2 from the object 406, the camera is controlled to capture a reference real-world image representing said object 406, by adjusting camera settings such that the representation of said object 406 in the reference real-world image fulfills the quality criteria. This means said object 406 in the reference real-world image is captured at a spatial resolution that is higher than the predefined threshold. Thus, in this scenario, the training data comprises reference data and input data, wherein the reference data comprises the reference real-world image, and the input data comprises the real-world image.

With reference to FIG. 4D, a user 400 wearing a display apparatus 402 (being implemented as a head-mounted display device) is shown to be present in a region 404 of a real-world environment. As shown, in the region 404, the user 400 is moving towards an object 406 (depicted using a dotted pattern) present in its field of view, while viewing said object 406. A dashed line representation of the user 400 indicates an initial position, a solid line representation of the user 400 indicates a final position, and an arrow in between these two positions indicates a motion of the user 400. When the user 400 is moving, a representation of the object 406 in a real-world image that is captured by a camera of the display apparatus 402, fails to satisfy a quality criteria (for example, absence of motion blur). This means said object 406 in the real-world image is captured with the motion blur. In such a case, when the user is at the final position (i.e., when the movement of the user 400 stops), the camera is controlled to capture a reference real-world image representing said object 406, by adjusting camera settings such that the representation of said object 406 in the reference real-world image fulfills the quality criteria. This means said object 406 in the reference real-world image is captured without any motion blur. Thus, in this scenario, the training data comprises reference data and input data, wherein the reference data comprises the reference real-world image, and the input data comprises the real-world image.

FIGS. 4A, 4B, 4C, and 4D are merely examples, which should not unduly limit the scope of the claims herein. The person skilled in the art will recognize many variations, alternatives, and modifications of embodiments of the present disclosure.

1. A method comprising:
determining a gaze point and a gaze depth of a user's eyes, by processing gaze-tracking data that is collected by a gaze-tracking means;
controlling at least one camera for capturing a real-world image of a real-world environment, by adjusting camera settings according to the gaze point and the gaze depth;
determining a pose of the at least one camera at a time of capturing the real-world image, by processing pose-tracking data that is collected by a pose-tracking means;
identifying at least one region of the real-world environment that is represented in the real-world image, based on a spatial geometry of the real-world environment and the pose of the at least one camera;
determining whether a representation of the at least one region in at least one of: the real-world image, a previously-captured real-world image, satisfies a quality criteria, wherein the previously-captured image is stored at a data repository;
when it is determined that the representation of the at least one region in the at least one of: the real-world image, the previously-captured real-world image, fails to satisfy the quality criteria, controlling the at least one camera for capturing a reference real-world image representing the at least one region, by adjusting the camera settings such that said representation fulfills the quality criteria;
generating training data comprising reference data and input data, wherein the reference data comprises the reference real-world image, and the input data comprises the at least one of: the real-world image, the previously-captured real-world image; and
sending the training data to a processor that is configured to train a first neural network for generating real-world images that satisfy the quality criteria by processing real-world images that fail to satisfy the quality criteria.

2. The method of claim 1, wherein the quality criteria comprises at least one of:
absence of defocus blur;
absence of motion blur;
absence of saturation;
absence of noise;
a spatial resolution being higher than a predefined threshold.

3. The method of claim 1, wherein the camera settings comprise at least one of: a focus distance, an exposure, a white balance, of the at least one camera.

4. The method of claim 1, the step of controlling the at least one camera for capturing the reference real-world image comprises:
determining reference values of the camera settings based on at least one of: an optical depth of the at least one region, lighting conditions in the at least one region, such that the reference values, when employed, enable the representation of the at least one region in the reference real-world image to satisfy the quality criteria; and
generating a control signal for the at least one camera to employ the determined reference values of the camera settings, for capturing the at least one reference real-world image.

5. The method of claim 1, further comprising:
receiving, from the processor, weights of the first neural network that are learnt upon the training of the first neural network at the processor;
transferring learning of the first neural network to a second neural network, by applying the weights to the second neural network; and
processing real-world images that do not satisfy the quality criteria, captured by the at least one camera after the step of transferring learning, for generating corresponding real-world images that satisfy the quality criteria, by employing the second neural network.

6. The method of claim 1, further comprising:
generating an extended-reality image using the real-world image; and
controlling at least one display, for displaying the extended-reality image.

7. The method of claim 1, further comprising:
generating at least one reprojected real-world image, by timewarping the real-world image, during a time period of controlling the at least one camera for capturing the reference real-world image, wherein upon elapsing of said time period, the method further comprises controlling the at least one camera for capturing a next real-world image;
generating at least one extended-reality image using the at least one reprojected real-world image; and
controlling at least one display, for displaying the at least one extended-reality image until a next extended-reality image that is generated using the next real-world image is generated for displaying.

8. The method of claim 1, further comprising:
when it is determined that the representation of the at least one region is represented in the at least one of: the real-world image, the previously-captured real-world image, satisfies the quality criteria, controlling the at least one camera for capturing an input real-world image representing the at least one region, by adjusting the camera settings such that said representation fails to satisfy the quality criteria;
generating training data comprising reference data and input data, wherein the reference data comprises the at least one of: the real-world image, the previously-captured real-world image, and the input data comprises the input real-world image; and
sending the training data to a processor that is configured to train a first neural network for generating real-world images that satisfy the quality criteria by processing real-world images that fail to satisfy the quality criteria.

9. The method of claim 1, further comprising determining the spatial geometry of the real-world environment, by processing sensor data that is collected by at least one depth sensor.

10. A display apparatus comprising:
a gaze-tracking means;
a pose-tracking means;
at least one camera; and
at least one processor configured to:
determine a gaze point and a gaze depth of a user's eyes, by processing gaze-tracking data that is collected by the gaze-tracking means;
control the at least one camera to capture a real-world image of a real-world environment, by adjusting camera settings according to the gaze point and the gaze depth;
determine a pose of the at least one camera at a time of capturing the real-world image, by processing pose-tracking data that is collected by the pose-tracking means;
identify at least one region of the real-world environment that is represented in the real-world image, based on a spatial geometry of the real-world environment and the pose of the at least one camera;
determine whether a representation of the at least one region in at least one of: the real-world image, a previously-captured real-world image, satisfies a quality criteria, wherein the previously-captured image is stored at a data repository that is communicably coupled with the at least one processor;
when it is determined that the representation of the at least one region in the at least one of: the real-world image, the previously-captured real-world image, fails to satisfy the quality criteria, control the at least one camera to capture a reference real-world image representing the at least one region, by adjusting the camera settings such that said representation fulfills the quality criteria;
generate training data comprising reference data and input data, wherein the reference data comprises the reference real-world image, and the input data comprises the at least one of: the real-world image, the previously-captured real-world image; and
send the training data to a processor that is configured to train a first neural network to generate real-world images that satisfy the quality criteria by processing real-world images that fail to satisfy the quality criteria.

11. The display apparatus of claim 10, wherein when controlling the at least one camera for capturing the reference real-world image, the at least one processor is configured to:
determine reference values of the camera settings based on at least one of: an optical depth of the at least one region, lighting conditions in the at least one region, such that the reference values, when employed, enable the representation of the at least one region in the reference real-world image to satisfy the quality criteria; and
generate a control signal for the at least one camera to employ the determined reference values of the camera settings, for capturing the at least one reference real-world image.

12. The display apparatus of claim 10- or 11, wherein the at least one processor is configured to:
receive, from the processor, weights of the first neural network that are learnt upon the training of the first neural network at the processor;
transfer learning of the first neural network to a second neural network, by applying the weights to the second neural network; and
process real-world images that do not satisfy the quality criteria, captured by the at least one camera after transferring said learning, to generate corresponding real-world images that satisfy the quality criteria, by employing the second neural network.

13. The display apparatus of any of claim 10, wherein the at least one processor is configured to:
generate an extended-reality image using the real-world image; and
control at least one display, for displaying the extended-reality image.

14. The display apparatus of claim 10, wherein the at least one processor is configured to:
generate at least one reprojected real-world image, by timewarping the real-world image, during a time period when the at least one camera is controlled for capturing the reference real-world image, wherein upon elapsing of said time period, the at least one processor is configured to control the at least one camera for capturing a next real-world image;
generate at least one extended-reality image using the at least one reprojected real-world image; and
control at least one display, for displaying the at least one extended-reality image until a next extended-reality image that is generated using the next real-world image is generated for displaying.

15. The display apparatus of claim 10, wherein the at least one processor is configured to:
when it is determined that the representation of the at least one region is represented in the at least one of: the real-world image, the previously-captured real-world image, satisfies the quality criteria, control the at least one camera to capture an input real-world image representing the at least one region, by adjusting the camera settings such that said representation fails to satisfy the quality criteria;
generate training data comprising reference data and input data, wherein the reference data comprises the at least one of: the real-world image, the previously-captured real-world image, and the input data comprises the input real-world image; and
send the training data to a processor that is configured to train a first neural network for generating real-world images that satisfy the quality criteria by processing real-world images that fail to satisfy the quality criteria.
